(19) United States
(12) Patent Application Publication
(10) Pub. No.: US 2023/0308238 A1
(43) Pub. Date: Sep. 28, 2023

(54) PILOT TRANSMISSION METHOD AND APPARATUS, NETWORK-SIDE DEVICE, AND STORAGE MEDIUM

(71) Applicant: VIVO MOBILE COMMUNICATION CO., LTD., Chang'an Dongguan (CN)

(72) Inventors: Pu YUAN, Chang'an Dongguan (CN); Hao LIU, Chang'an Dongguan (CN); Dajie JIANG, Chang'an Dongguan (CN)

(21) Appl. No.: 18/204,665

(22) Filed: Jun. 1, 2023

Related U.S. Application Data
(63) Continuation of application No. PCT/CN2021/136068, filed on Dec. 7, 2021.

(30) Foreign Application Priority Data
Dec. 11, 2020 (CN) 202011460560.7

(51) Int. Cl. H04L 5/00; H04B 7/06

(52) U.S. Cl. CPC H04L 5/0048; H04B 7/06968

(57) ABSTRACT

Disclosed in this application are a pilot transmission method and apparatus, a network-side device, and a storage medium. The method is applied to a network-side device and includes: determining at least one pilot resource block in a delay-Doppler domain; and mapping pilots corresponding to a plurality of antenna ports to the at least one pilot resource block for transmission, where a pilot corresponding to one antenna port is mapped to one pilot resource block in the at least one pilot resource block.

### CROSS-REFERENCE TO RELATED APPLICATIONS

This application is a continuation of International Application No. PCT/CN2021/136068, filed on Dec. 7, 2021, which claims priority to Chinese Patent Application No. 202011460560.7, filed in China on Dec. 11, 2020, which are incorporated herein by reference in their entireties.

### TECHNICAL FIELD

This application relates to the field of communication technologies, and particularly, to a pilot transmission method and apparatus, a network-side device, and a storage medium.

### BACKGROUND

When channel estimation is performed in an orthogonal time frequency (OTFS) modulation system, a transmitter maps a pilot pulse to a delay-Doppler domain, and a receive end uses delay-Doppler image analysis of the pilot to estimate a channel response of the delay-Doppler domain, so that a channel response expression of a time-frequency domain can be obtained, thereby facilitating application of an existing technology of the time-frequency domain for signal analysis and processing.

In the prior art, when a plurality of antenna ports perform pilot transmission, two schemes are used generally. A first scheme is that a pilot and pilot guard band corresponding to each antenna port are transmitted independently on their respective resource blocks. However, such a scheme results in a linear increase in resource overheads because resource multiplexing cannot be performed in a scheme of a single-point pilot plus a guard band. A second scheme is that pilots of the plurality of antenna ports are constructed into a pilot sequence by using a pseudorandom noise (PN) sequence. However, such a scheme leads to high pilot detection complexity after the receive end receives a signal, and detection accuracy is limited by a length of the sequence.

### SUMMARY

According to a first aspect of the present disclosure, a pilot transmission method is provided, applied to a network-side device and includes:
determining at least one pilot resource block in a delay-Doppler domain; and
mapping pilots corresponding to a plurality of antenna ports to the at least one pilot resource block for transmission, where
a pilot corresponding to one antenna port is mapped to one pilot resource block in the at least one pilot resource block.

According to a second aspect of the present disclosure, a pilot transmission apparatus is provided, applied to a network-side device. The apparatus includes:
a first determining module, configured to determine at least one pilot resource block in a delay-Doppler domain; and
a first mapping module, configured to map pilots corresponding to a plurality of antenna ports to the at least one pilot resource block for transmission, where
a pilot corresponding to one antenna port is mapped to one pilot resource block in the at least one pilot resource block.

According to a third aspect of the present disclosure, a network-side device is provided, including a processor, a memory, and a program or instructions stored in the memory and runnable on the processor, where when the program or instructions are executed by the processor, the steps of the method according to the first aspect are implemented.

According to a fourth aspect of the present disclosure, a readable storage medium is provided, storing a program or instructions, where when the program or instructions are executed by a processor, the steps of the method according to the first aspect are implemented.

According to a fifth aspect of the present disclosure, a chip is provided, including a processor and a communication interface, where the communication interface is coupled to the processor, and the processor is configured to run a program or instructions of a network-side device to implement the method according to the first aspect.

### BRIEF DESCRIPTION OF THE DRAWINGS

FIG. 1 is a block diagram of a wireless communication system according to an embodiment of this application;

FIG. 2 is a schematic diagram of a mutual conversion of a delay-Doppler domain and a time-frequency plane according to an embodiment of this application;

FIG. 3 is a schematic diagram of a relationship among channel responses under different planes according to an embodiment of this application;

FIG. 4 is a schematic flowchart of transmit and receive end processing of an OTFS multicarrier system according to an embodiment of this application;

FIG. 5 is a schematic diagram of pilot mapping in a delay-Doppler domain according to an embodiment of this application;

FIG. 6 is a schematic diagram of pilot location detection at a receive end side according to an embodiment of this application;

FIG. 7 is a schematic diagram of mapping of a multi-port reference signal in a delay-Doppler domain according to an embodiment of this application;

FIG. 8 is a schematic diagram of pilot resource multiplexing in a delay-Doppler domain according to an embodiment of this application;

FIG. 9 is a schematic diagram of detection of a pilot sequence according to an embodiment of this application;

FIG. 10 is a schematic diagram of a performance comparison between two pilot design schemes under different pilot overheads according to an embodiment of this application;

FIG. 11 is a schematic diagram of definition of QCL relationships according to an embodiment of this application;

FIG. 12 is a schematic flowchart of a pilot transmission method according to an embodiment of this application;

FIG. 13 is a schematic diagram of pilot resource block configuration according to an embodiment of this application;

FIG. 14 is a first schematic diagram of channel measurement according to an embodiment of this application;

FIG. 15 is a second schematic diagram of channel measurement according to an embodiment of this application;

FIG. 16 is a schematic structural diagram of a pilot transmission apparatus according to an embodiment of this application;

FIG. 17 is a schematic structural diagram of a communication device according to an embodiment of this application; and

FIG. 18 is a schematic diagram of a hardware structure of a network-side device according to an embodiment of this application.

### DETAILED DESCRIPTION

The following clearly and completely describes the technical solutions in the embodiments of this application with reference to the accompanying drawings in the embodiments of this application. Apparently, the described embodiments are some of the embodiments of this application rather than all of the embodiments. All other embodiments derived by a person of ordinary skill in the art based on the embodiments of this application without creative efforts shall fall within the protection scope of this application.

In the specification and claims of this application, the terms “first”, “second”, and the like are used to distinguish similar objects, but are not used to describe a specific sequence or order. It may be understood that the data used in such a way is interchangeable in proper circumstances, so that the embodiments of this application described herein can be implemented in other sequences than the sequence illustrated or described herein, and the objects distinguished through “first” and “second” are generally of a same type and the number of the objects are not limited, for example, a first object may be one or more than one. In addition, “and/or” in this specification and the claims represents at least one of the connected objects, and a character “/” used herein indicates an “or” relationship between associated objects.

It is to be noted that the technologies described in the embodiments of this application are not limited to a long term evolution (LTE)/LTE-advanced (LTE-A) system, and may be further applied to other wireless communication systems such as code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” in the embodiments of this application are often used interchangeably, and the technologies described can be applied to the systems and radio technologies mentioned above, and can also be applied to other systems and radio technologies. However, the following describes a new radio (NR) system for the purpose of illustration, and NR terms are used in most of the description below, although these technologies can also be applied to applications other than NR system applications, for example, the 6^{th} generation (6G) communication system.

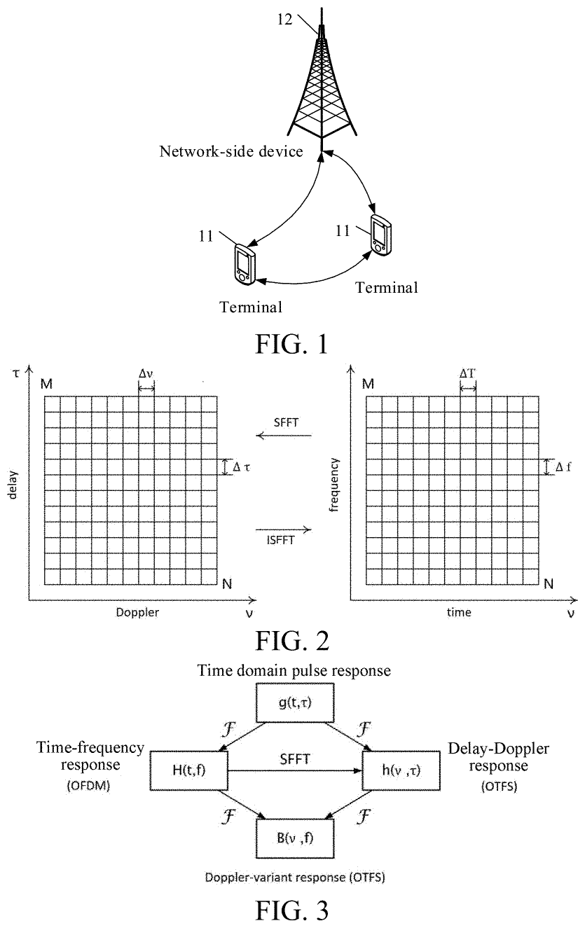

FIG. 1 is a block diagram of a wireless communication system according to an embodiment of this application. The wireless communication system includes a terminal 11 and a network-side device 12. The terminal 11 may also be referred to as a terminal device or user equipment (UE), and the terminal 11 may be a terminal-side device, such as a mobile phone, a tablet personal computer, a laptop computer or a notebook computer, a personal digital assistant (PDA), a handheld computer, a netbook, an ultra-mobile personal computer (UMPC), a mobile Internet device (MID), a wearable device, vehicle user equipment (VUE), or pedestrian user equipment (PUE). The wearable device includes: a hand ring, a headset, a pair of glasses, or the like. It is to be noted that, a specific type of the terminal 11 is not limited in the embodiments of this application. The network-side device 12 may be a base station or a core network, where the base station may be referred to as a NodeB, an evolved NodeB, an access point, a base transceiver station (BTS), a radio base station, a radio transceiver, a basic service set (BBS), an extended service set (ESS), a B node, an evolved B node (eNB), a home B node, a home evolved B node, a WLAN access point, a WiFi node, a transmission reception point (TRP), or any proper term in the field, provided that a same technical effect can be reached. The base station is not limited to a specific technical word. It is to be noted that, the base station in the NR system is only used as an example in the embodiments of this application, but a specific type of the base station is not limited.

For ease of description, the following content is described first:
downlink control information (DCI);
physical downlink control channel (PDCCH);
physical downlink shared channel (PDSCH);
radio resource control (RRC);
physical broadcast channel (PBCH);
master information block (MIB);
system information block (SIB);
resource element (RE); and
code division multiplexing (CDM).

In a complex electromagnetic wave transmission environment in a city, due to existence of a large number of scattering, reflection and refraction surfaces, a wireless signal reaches a receive antenna through different paths at different times, that is, a multipath effect of transmission is caused. Inter symbol interference (inter symbol interference, ISI) occurs when a previous symbol and a latter symbol of a sent signal simultaneously arrive through different paths, or when a latter symbol arrives within a delay spread of a previous symbol. Similarly, in a frequency domain, due to a Doppler effect caused by a relative velocity between a transmit end and a receive end, various subcarriers where a signal is located have different degrees of offsets in frequency, resulting in overlapping of subcarriers that may originally be orthogonal, that is, generating inter carrier interference (ICI). An orthogonal frequency division multiplexing (OFDM) multicarrier system used in an existing protocol has better anti-ISI performance through a design of adding a cyclic prefix (CP). However, a weakness of OFDM is that a subcarrier spacing size is limited. Therefore, in response to a high-speed moving scenario (such as a high-speed train), due to a greater Doppler shift brought by a greater relative velocity between the transmit end and the receive end, orthogonality between OFDM subcarriers is destroyed, resulting in serious ICI between the subcarriers.

An orthogonal time frequency space (OTFS) technology is designed to resolve the foregoing problems in the OFDM system. Transformation between a delay-Doppler domain and a time-frequency domain is defined in the OTFS technology. By simultaneously mapping service data and pilots from the transmit end and the receive end to the delay-Doppler domain for processing, by designing the pilots in the delay-Doppler domain to capture a delay feature and a Doppler feature of a channel, and by designing a guard interval, a pilot pollution problem caused by the ICI in the OFDM system is avoided, so that channel estimation is more accurate, thereby being conducive to improving a success rate of data decoding at the receive end.

In the OTFS technology, a pilot symbol located in the delay-Doppler domain needs to be surrounded by the guard interval, and a size of the guard interval is related to a channel feature. In this application, by measuring a channel, the size of the guard interval of the pilot symbol is dynamically adjusted according to the channel feature, to ensure that pilot overheads are approximately minimized under a premise of satisfying a system design, thereby avoiding a waste of resources caused by a worst case that is always taken into account in a traditional scheme.

The delay feature and the Doppler feature of the channel are essentially determined by a multipath channel. For signals that reach the receive end through different paths, because there is a difference between transmission distances, arrival times are also different. For example, if two echoes s₁ and s₂ independently experience distances d₁ and d₂ to arrive at the receive end, a difference between their arrival times at the receive end is:

$$Δt = \frac{\vert {d}_{1} - {d}_{2} \vert}{c} ,$$

where c is a speed of light.

Because of this time difference between the echoes s₁ and s₂, their coherent superposition on a receive end side causes amplitude jitter of an observed signal, that is, a fading effect. Similarly, Doppler spread of the multipath channel is also caused by the multipath effect.

The Doppler effect is caused by existence of the relative velocity at the transmit end and the receive end. Because there is a difference in incident angles relative to an antenna normal between the signals reaching the receive end through different paths, a difference in the relative velocity is caused, thereby resulting in a difference in Doppler shifts of the signals on the different paths. Assuming that an original frequency of a signal is f₀, a relative velocity of a transmit end and a receive end is Δv, and an incident angle between the signal and a normal of an receive end antenna is θ, there is:

$$Δ f = \frac{Δ v}{f} cos θ .$$

Apparently, when the two echoes s₁ and s₂ pass through different paths to arrive at the receive end antenna and have different incident angles θ₁ and θ₂, their obtained Doppler shifts Δf₁ and Δf₂ are also different.

In summary, a signal received by the receive end is superposition of component signals that have different delays and Doppler shifts and that are from different paths, which is represented as a received signal having attenuation and a shift relative to an original signal as a whole. Performing delay-Doppler analysis on a channel is conducive to collecting delay-Doppler information of each path, thereby reflecting a delay-Doppler response of the channel.

Orthogonal time frequency space modulation is a full name for the OTFS modulation technology. The technology logically maps information in a data packet whose size is M×N for example, a quadrature amplitude modulation (Quadrature Amplitude Modulation, QAM) symbol, to an A×N grid in a two-dimensional delay-Doppler domain, that is, a pulse in each grid modulates one QAM symbol in the data packet.

FIG. 2 is a schematic diagram of a mutual conversion of a delay-Doppler domain and a time-frequency plane according to an embodiment of this application. As shown in FIG. 2, by designing a group of orthogonal two-dimensional basis functions, a data set on an M×N delay-Doppler domain plane is transformed to a N×M time-frequency domain plane. Such transformation is referred to as an inverse symplectic finite Fourier transform (ISFFT) on mathematic. Correspondingly, transformation from a time-frequency domain to a delay-Doppler domain is referred to as a symplectic finite Fourier transform (SFFT). A physical meaning behind is that a delay and Doppler effect of a signal is actually a linear superposition effect of a series of echoes having different time and frequency offsets after the signal passes through a multipath channel. In this sense, delay-Doppler analysis and time-frequency domain analysis may be obtained by a mutual conversion of the foregoing ISFFT and SFFT.

In this way, the OTFS technology transforms a time-varying multipath channel into a (within certain duration) time-independent two-dimensional delay-Doppler domain channel, thereby directly representing a channel delay-Doppler response feature caused by a geometry feature of a relative location of reflectors between transceivers in a wireless link. An advantage of this is that the OTFS eliminates the difficulties in tracking a time-varying fading feature in traditional time-frequency domain analysis, thereby extracting all diversity features of a time-frequency domain channel through delay-Doppler domain analysis. In an actual system, a channel impulse response matrix represented by the delay-Doppler domain is sparse because a number of delay paths and Doppler shifts of the channel is much smaller than a number of time domain and frequency domain responses of the channel. Using the OTFS technology to analyze a sparse channel matrix in the delay-Doppler domain can enable more compact and flexible packing of reference signals, and is particularly conducive to supporting a large antenna array in a massive MIMO system.

A core of OTFS modulation is that a QAM symbol defined in the delay-Doppler domain is transformed into the time-frequency domain for sending, and then the receive end returns to the delay-Doppler domain for processing. Therefore, a radio channel response analysis method in the delay-Doppler domain may be introduced.

FIG. 3 is a schematic diagram of a relationship among channel responses under different planes according to an embodiment of this application. FIG. 3 shows a relationship of expressions of channel responses under different planes when a signal passes through a linear time-varying wireless channel.

In FIG. 3, a transformation formula for the SFFT is:

h(τ,v)=∫∫H(t,f)e^{-j2π(vt-fτ)}dτdv; (1)

and correspondingly, a transformation formula for the ISFFT is:

H(t,f)=∫∫h(τ,v)e^{j2π(vt-fτ)}dτdv (2)

When the signal passes through the linear time-varying wireless channel, a signal received in a time domain is r(t), a signal received in a corresponding frequency domain is R(f), and r(t)=F⁻¹ {R(f)} r (t) may be represented in the following form:

(t)=s(t)*h(t)=∫g(t,τ)s(t−τ)dτ. (3)

It can be learned from the relationship in FIG. 3 that:

g(t,τ)=∫h(v,τ)e^{j2πvt}dv. (4)

(4) is substituted into (3) to obtain:

r(t)=∫∫h(v,τ)s(t−τ)e^{j2πvt}dτdv (5)

It can be learned from the relationship in FIG. 3, a classical Fourier transform theory, and the formula (5) that:

$$r ( t ) \& = \int \int h ( v , τ ) ( \int S ( f ) {e}^{j2 π f ( t - τ )} df ) {e}^{j2 π vt} d τ dv = \int ( \int \int h ( v , τ ) {e}^{j2 π ( vt - f τ )} d τ dv ) S ( f ) {e}^{j2 π ft} df = \int H ( t , f ) S ( f ) {e}^{j2 π ft} df = {F}^{- 1} \{ R ( f ) \} . \qquad ( 6 )$$

Equation (6) implies that performing delay-Doppler domain analysis in an OTFS system may be implemented by relying on an existing communication framework established on a time-frequency domain and adding additional signal processing processes at a transmit end and a receive end. In addition, the additional signal processing is only formed by a Fourier transform, and can be implemented entirely through existing hardware without adding a module. This good compatibility with an existing hardware system greatly facilitates application of the OTFS system. In an actual system, an OTFS technology can be easily implemented as a pre-processing module and a post-processing module for a filtered OFDM system, thereby having good compatibility with an existing multicarrier system.

When OTFS is combined with the multicarrier system, an implementation of the transmit end is as follows: a QAM symbol containing to-be-sent information is carried by a waveform of a delay-Doppler domain, is converted into a waveform of a time-frequency domain plane in a traditional multicarrier system through a two-dimensional inverse symplectic finite Fourier transform (Inverse Symplectic Finite Fourier Transform, ISFFT), and then is sent as a time domain sampling point converted through a symbol-level one-dimensional inverse fast Fourier transform (Inverse Fast Fourier Transform, IFFT) and serial-to-parallel conversion.

An implementation of the receive end of the OTFS system is roughly an inverse process of that of the transmit end: after being received by the receive end, the time domain sampling point is first transformed into a waveform on a time-frequency domain plane through parallel-serial conversion and a symbol-level one-dimensional fast Fourier transform (FFT), and then is converted into a waveform on a delay-Doppler domain plane through a two-dimensional symplectic finite Fourier transform (SFFT), and then the QAM symbol carried by the waveform of the delay-Doppler domain is processed at the receive end, which includes but is not limited to channel estimation and equalization, demodulation, decoding, and the like.

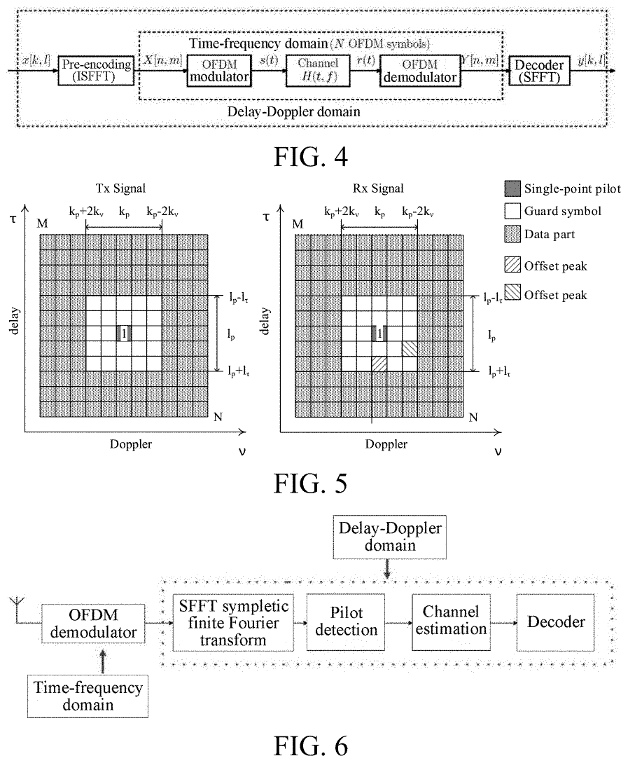

FIG. 4 is a schematic flowchart of transmit and receive end processing of an OTFS multicarrier system according to an embodiment of this application.

Advantages of OTFS modulation are mainly reflected in the following aspects:

(1) The OTFS modulation converts a time-varying fading channel in the time-frequency domain between transceivers into a deterministic non-fading channel in the delay-Doppler domain. In the delay-Doppler domain, each symbol in a group of information symbols sent once experiences a same static channel response and SNR.

(2) An OTFS system parses a reflector in a physical channel by using a delay-Doppler image, and coherently combines energy from different reflection paths with a receiver equalizer, actually providing a non-fading static channel response. Using the static channel feature, the OTFS system does not need to introduce closed-loop channel adaptation like an OFDM system to handle a fast-changing channel, thereby improving system robustness and reducing system design complexity.

(3) Because a number of delay-Doppler states in the delay-Doppler domain is much smaller than a number of time-frequency states in the time-frequency domain, a channel in the OTFS system may be expressed in a very compact form. Channel estimation for the OTFS system is less expensive and more accurate.

(4) Another advantage of OTFS is reflected in handling an extreme Doppler channel. Through analysis of the delay-Doppler image with an appropriate signal processing parameter, a Doppler feature of the channel is fully presented, thereby facilitating signal analysis and processing under a Doppler-sensitive scenario (such as high-speed movement or millimeter wave).

Based on the above analysis, channel estimation in the OTFS system can adopt a completely new method. A transmitter maps a pilot pulse to the delay-Doppler domain, and the receive end uses the delay-Doppler image analysis for the pilot to estimate a channel response h(v,τ) of the delay-Doppler domain, so that a channel response expression of the time-frequency domain can be obtained according to the relationship shown in FIG. 3, which facilitates the signal analysis and processing of an existing technology to which the time-frequency domain is applied.

FIG. 5 is a schematic diagram of pilot mapping in a delay-Doppler domain according to an embodiment of this application. FIG. 5 shows an adoptable manner for the pilot mapping in the delay-Doppler domain. A sent signal in FIG. 5 is formed by a single-point pilot (a small block labeled as 1) located at (lₚ, kₚ), guard symbols (no shadow part) that surround the single-point pilot and have an area of (2l_{τ}+1)(4kᵥ+1)−1, and a data part (a region other than the guard symbols) with an area of MN−(2l_{τ}+1)(4kᵥ+1). At the receive end, two offset peaks (slash shaded parts) appear in a guard band of a grid in the delay-Doppler domain, meaning that a channel has two secondary paths with different delays and Dopplers in addition to a main path. By measuring amplitude, delays, and Doppler parameters of all secondary paths, an expression for the delay-Doppler domain of the channel is obtained, that is, h(v,τ).

In particular, to prevent a pilot symbol from being contaminated by data on a grid of a received signal, resulting in inaccurate channel estimation, the area of the guard symbols should satisfy the following conditions:

l_{τ}≥τₘₐₓMΔf;kᵥ≥vₘₐₓNΔT,

where τₘₐₓ and vₘₐₓ are respectively a maximum delay and a maximum Doppler shift for all paths of the channel.

FIG. 6 is a schematic diagram of pilot location detection at a receive end side according to an embodiment of this application. As shown in FIG. 6, a main process for the pilot location detection is: OFDM demodulator→SFFT symplectic finite Fourier transform→pilot detection→channel estimation→decoder. A receive end converts a received time domain sampling point, through the OFDM demodulator and an OTFS transformation (the SFFT in the figure) process, into a QAM symbol of a delay-Doppler domain, and then uses threshold-based signal power detection to determine a location of a pilot pulse. It is worth noting that, because pilot sending usually increases a power boost, a power of the pilot pulse at the receive end is much greater than a data power. In addition, because the pilot pulse and a data symbol experience exactly same fading, it is easy to determine a pilot location by using power detection.

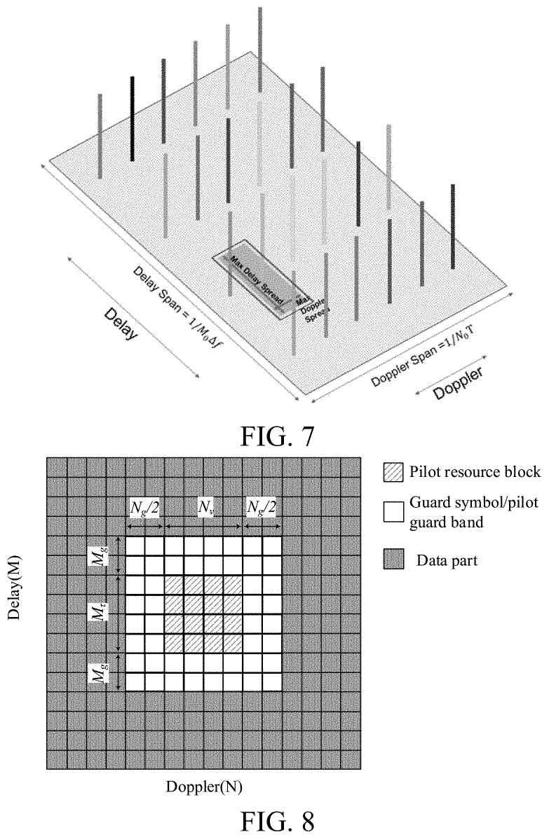

The method provided in FIG. 5 corresponds to a single-port scenario where only one group of reference signals needs to be sent. In a modern multi-antenna system, a plurality of antenna ports are often used to simultaneously send multi-stream data, to make full use of a spatial degree of freedom of an antenna to achieve a purpose of obtaining a space diversity gain or improving a system throughput. FIG. 7 is a schematic diagram of mapping of a multi-port reference signal in a delay-Doppler domain according to an embodiment of this application. When a plurality of antenna ports exist, a plurality of pilots need to be mapped in the delay-Doppler domain, so that there is a pilot mapping manner as shown in FIG. 7.

In FIG. 7, 24 antenna ports correspond to 24 pilot signals. Each of the pilot signals takes the form shown in FIG. 5, that is, a mode of an impulse signal at a center point plus guard symbols around the impulse signal. A number of delay-Doppler domain REs (resource elements) occupied by a single pilot is (2l_{τ}+1)(4kᵥ+1). If there are P antenna ports, considering that guard bands adjacent to antenna ports may be reused, assuming that a pilot is placed at a delay dimension of P₁, at a Doppler dimension of P₂, and P=P₁P₂ is satisfied, total resource overheads of the pilot is [P₁(l_{τ}+1)+l_{τ}][P₂(2kᵥ+1)+2kᵥ].

FIG. 8 is a schematic diagram of pilot resource multiplexing in a delay-Doppler domain according to an embodiment of this application. It can be seen that although single-port transmission has an advantage of less resource occupation and a simple detection algorithm, for a communication system with a plurality of antenna ports, there is a linear increase in overheads because resource multiplexing cannot be performed in a scheme of a single-point pilot plus a guard band. Therefore, for a multi-antenna system, a pilot mapping scheme as shown in FIG. 8 is proposed.

In FIG. 8, a pilot does not exist in the form of a single-point pulse, but a pilot sequence constructed based on a PN sequence generated in a specified manner and is mapped, according to a specified rule, to a two-dimensional resource grid in the delay-Doppler domain, that is, a slash shaded part in the figure. In this application, a resource location, that is, the slash shaded part, occupied by the pilot sequence may be referred to as a pilot resource block. A shadowless region next to the pilot resource block is a pilot guard band, formed by blank resource elements that do not send any signal/data. Similar to the foregoing single-point pilot, a guard band is also arranged to surround the single-point pilot to avoid interference with the data. A method for calculating a width of the guard band is the same as a method in the single-point pilot mapping mode in FIG. 5. A difference is that in a resource part to which the pilot sequence is mapped, pilot signals of different ports may select to generate sequences with a low correlation. The sequences are superposed and mapped to a same resource block, and then detection of the pilot sequence is performed at a receive end through a specified algorithm, to distinguish pilots corresponding to different antenna ports. Because complete resource multiplexing is performed at a transmit end, pilot overheads under the multi-antenna port system may be greatly reduced.

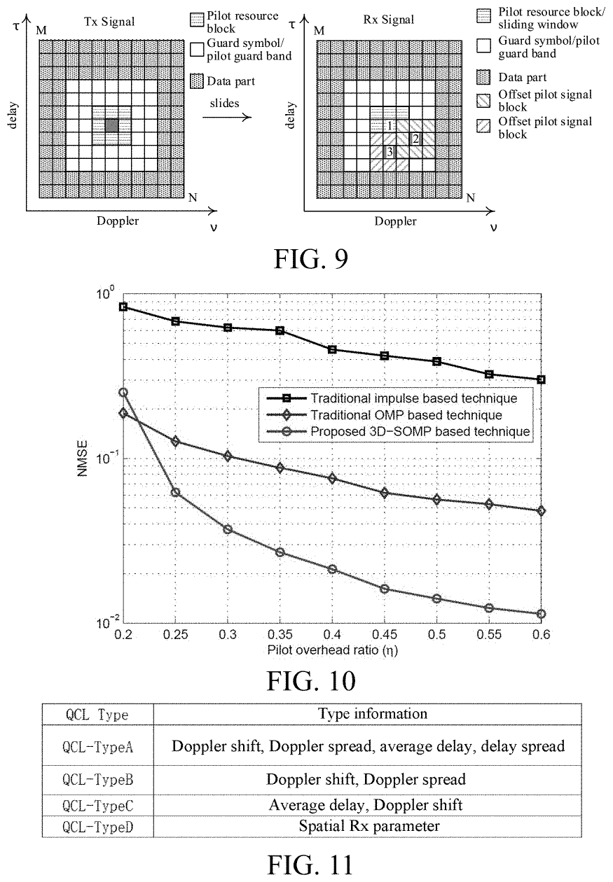

FIG. 9 is a schematic diagram of detection of a pilot sequence according to an embodiment of this application. As shown in FIG. 9, a pilot sequence-based detection manner is presented. Similar to the foregoing scenario in FIG. 5, at the receive end, due to the different delays and Doppler shifts of the two paths of the channel, received pilot signal blocks are offset as a whole in the delay-Doppler domain to positions of blocks of the slash shaded part in the figure (that is, a block labeled as 2 and 8 blocks adjacent to the block labeled as 2, and a block labeled as 3 and 8 blocks adjacent to the block labeled as 3). In this case, a sliding window detection operation is performed in the delay-Doppler domain by using a known sent pilot (a horizontal shaded part in the figure, that is, a block labeled as 1 and 8 blocks adjacent to the block labeled as 1) at the receive end. It is known that when N_{P}→+∞, a sliding window detection operation result M(R,S)[δ,ω] has the following properties (a probability of the following formula is close to 1):

M(R,S)[δ,ω]=1+ε′_{N}_{_{P}}, if (δ,ω)=(δ₀,ω₀)=ε_{N}_{_{P}}, if (δ,ω)≠(δ₀,ω₀).

$$\vert {{ε}^{′}}_{{N}_{P}} \vert \leq \frac{1}{\sqrt{{N}_{P}}} ,$$

$$\vert {ε}_{{N}_{P}} \vert \leq \frac{C + 1}{\sqrt{{N}_{P}}} ,$$

and C>0 is a constant.

(δ,ω) and (δ₀,ω₀) in the formula are respectively a current (center point) position of a sliding window, and a position to which pilot signal blocks (center point) in a received signal are offset. It can be seen from the formula that only when (δ, ω)=(δ₀, ω₀), a value near 1 can be obtained; otherwise the sliding window detection operation result is a smaller value. Therefore, when the sliding window (the horizontal shaded part in the figure, that is, the block labeled as 1 and the 8 blocks adjacent to the block labeled as 1) coincides with the offset pilot signal blocks (the slash shaded part in the figure, that is, the block labeled as 2 and the 8 blocks adjacent to the block labeled as 2, and the block labeled as 3 and the 8 blocks adjacent to the block labeled as 3), a detection machine calculates an energy peak value, presented at a position (δ₀, ω₀) in the delay-Doppler domain, that is, positions of the small blocks labeled as 2 and 3 in the figure. Using this method, as long as it is ensured that N_{P} has a sufficient length, the receive end can obtain a correct pilot position according to a value of M(R,S) that is, obtain delay and Doppler information of the channel. In addition, an amplitude value of the channel is given by a value of 1+ε′_{N}_{_{P}} obtained through the detection operation.

By comparison, the scheme (simply referred to as the pilot sequence) in FIG. 8 and the scheme (simply referred to as the pilot pulse) in FIG. 7, have their own advantages and disadvantages. Advantages of the pilot sequence scheme are as follows:
(1) it is conducive to multi-port/multi-user multiplexing;
(2) accuracy of sequence detection may be flexibly adjusted;
(3) overheads for guard symbols is reduced; and
(4) even if the overheads are insufficient (that is, a reserved width of the pilot guard band is less than a width calculated according to the maximum delay and the maximum Doppler of the channel to ensure no interference between data and pilot at the receive end), a certain degree of channel estimation accuracy can be maintained to ensure that a performance loss of the system is within an acceptable range.

Disadvantages are as follows:
(1) sequence correlation/matching detection complexity is high; and
(2) accuracy is limited by a sequence length, and when the sequence length is long, the overheads for the pilot and pilot guard band is high.

Advantages of the pilot pulse scheme are as follows:
(1) the receive end only needs to use power detection, and an algorithm is simple; and
(2) a detection success rate may be improved through a power boost (power boost, that is, a transmitter independently increases a transmitting power of the pilot signal).

Disadvantages are as follows:
(1) each pilot pulse needs to be arranged with an independent guard band, and overheads is high in multi-port transmission.

The above advantages and disadvantages can summarize performances of the two schemes in various scenarios.

In addition, in some scenarios, overheads of a pilot guard interval is limited and is not enough to completely cover a possible delay and Doppler shift of the channel. In this case, the pilot sequence scheme still shows acceptable performance, while the pilot pulse scheme suffers a great performance loss.

FIG. 10 is a schematic diagram of a performance comparison between two pilot design schemes under different pilot overheads according to an embodiment of this application. As shown in FIG. 10, diamond-shaped and circular-shaped polylines in the figure are performance curves of a pilot sequence scheme based on different detection algorithms, while a square-shaped polyline is a performance curve of a pilot pulse scheme. It can be seen that in the illustrated special scenario (delay and Doppler shift of a channel is large), even if a pilot overhead reaches 60%, a performance of the pilot pulse scheme is still far worse than that of the pilot sequence scheme.

In addition, a quasi co-location (QCL) relationship is defined in a communication system to describe channel similarity between different reference signals, between a reference signal and an antenna port, and between antenna ports. FIG. 11 is a schematic diagram of a definition of QCL relationships according to an embodiment of this application. As shown in FIG. 11, according to different statistical measurement values that measure channel similarity, a communication system may support, but is not limited to, several types of QCL relationships as shown in FIG. 11.

In FIG. 11, QCL information is indicated to a UE by a base station, so that the UE can obtain certain prior information when processing a currently received signal/data, thereby processing in a targeted manner and improving performance of a receive end. For example, when the base station indicates a QCL-TypeC relationship between a group of synchronization signal and PBCH blocks (SSB) and a tracking reference signal (TRS) antenna port, the receive end may correctly find, according to a timing relationship determined by the SSBs and a frequency offset estimated by the SSBs (reflected on a Doppler shift), a time domain sampling point at which a TRS is located and perform frequency offset compensation processing on the time domain sampling point, thereby using the TRS for channel estimation more accurately. For another example, when the base station indicates a QCL-TypeD relationship between a group of TRSs and a DMRS port, a receive antenna port may receive a DMRS by using a same spatial reception parameter (that is, a receive beam) previously received, thereby reducing beam scanning overheads in a stage of receiving the DMRS.

A sequence-based pilot design scheme shows significant advantages over multiple antenna ports, but still has the following disadvantages.
(1) In the prior art, PN sequences are simply used to superpose at a same resource location, and when a number of superposed layers is large, there is a risk that a probability of false detection is high due to a low SNR of a received signal.
(2) The PN sequences used in the prior art are not completely orthogonal between different sequences. The more sequences to be detected, the higher probability of nominal detection/false detection. Therefore, there is also some room for improvement in a sequence design.
(3) In the prior art, only different PN sequences are simply used to indicate different ports. If additional information can be added to a sequence generation manner, and the sequence can be reused to indicate other useful information, an objective of reducing pilot overheads can be implemented in disguise and system performance can be further improved.
(4) A sequence-based pilot design is more complicated than a pilot pulse design, proposing new design requirements for up-and-down indication messages, feedback messages, and interaction processes, while a design and elaboration in this aspect are lacked in the prior art.

In summary, the prior art still has large room for improvement, and this application proposes a pilot transmission method and apparatus, for the foregoing defects to make targeted improvements.

The pilot transmission method according to the embodiments of this application is described in detail below with reference to the accompanying drawings through specific embodiments and application scenarios thereof.

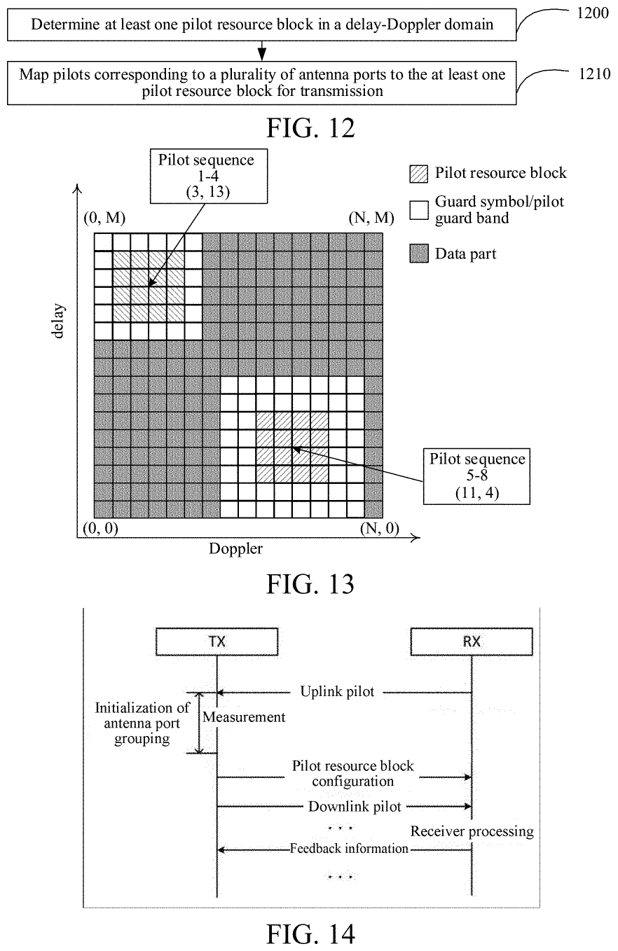

FIG. 12 is a schematic flowchart of a pilot transmission method according to an embodiment of this application. As shown in FIG. 12, the method is applied to a network-side device, and includes the following steps.

Step 1200: Determine at least one pilot resource block in a delay-Doppler domain.

Step 1210: Map pilots corresponding to a plurality of antenna ports to the at least one pilot resource block for transmission.

A pilot corresponding to one antenna port is mapped to one pilot resource block in the at least one pilot resource block.

In some embodiments, pilot sequences corresponding to the plurality of antenna ports may be mapped to one or more pilot resource blocks.

Therefore, the one or more pilot resource blocks may be determined in the delay-Doppler domain, and then the pilots corresponding to the plurality of antenna ports may be mapped to the pilot resource block for transmission.

In some embodiments, the at least one pilot resource block may be determined in the delay-Doppler domain, and the pilots corresponding to the plurality of antenna ports may be mapped to the at least one pilot resource block for transmission.

In some embodiments, a number of pilot resource blocks may be one, or may be the same as a number of antenna ports, or may be more than one and less than the number of antenna ports, reaching a balance between pilot measurement accuracy and pilot overheads.

It may be understood that, the pilot corresponding to one antenna port is mapped to only one pilot resource block for transmission, and pilots corresponding to one or more different antenna ports may be mapped to one pilot resource block.

In some embodiments, the pilot transmission method according to this embodiment of this application is performed by a network-side device, for example, a base station-side. Therefore, in this embodiment of this application, a transmit end is a network side, and a receive end is a terminal.

This embodiment of this application proposes a sequence-based pilot design improvement scheme in a delay-Doppler system. The scheme may define a multi-antenna port pilot mapping manner applicable to different scenarios, to obtain a balance between pilot measurement accuracy and overheads under different channel conditions, thereby maximizing a system throughput.

In this embodiment of this application, by mapping pilots corresponding to a plurality of antenna ports to at least one pilot resource block in a delay-Doppler domain for transmission, a defect of high resource overheads caused by a single-point pilot mapping manner is avoided, a defect of detection performance reduction and high complexity caused by constructing the pilots corresponding to the plurality of antenna ports into a pilot sequence through a PN sequence is also avoided, so that pilot overheads in a multi-antenna port system can be reduced, and reliability of system performance can also be ensured.

In some embodiments, the mapping pilots corresponding to a plurality of antenna ports to the at least one pilot resource block for transmission includes:

mapping, based on quasi co-location (Quasi-co-location, QCL) type information of the plurality of antenna ports, pilots corresponding to antenna ports having a QCL relationship to a first pilot resource block for transmission.

In some embodiments, when channel statistical features of two or more antenna ports are similar, these antennas may be used at a same resource location, thereby reasonably arranging a guard band size and optimizing resource overheads.

In some embodiments, to reduce overheads brought by channel measurement, a QCL relationship between different pilots/antenna ports may be used to directly determine pilot group information, that is, it may be determined that antenna ports with similar channel statistic features are classified into one group, and a width of a pilot guard band is calculated, to achieve a purpose of reducing measurement feedback overheads and reducing a delay.

For example, if a current group of antenna ports for sending pilots have a QCL-TypeC relationship with an SSB, it may be considered that delay/Doppler features of channels of the antenna ports and delay/Doppler features of the SSB channel are the same, and a mapping relationship between the channel statistical features reflected by the QCL relationship and the pilot guard band may be predefined in a protocol. Then the transmit end may directly determine grouping of pilot antenna ports of other measurement signal QCL and a size of the pilot guard band size according to a result obtained by another measurement signal, thereby reducing overheads.

In some embodiments, the transmit end may indicate the QCL relationship to a UE, and the UE may obtain group information of the pilot antenna ports and size information of the pilot guard band according to the protocol-defined mapping relationship, thereby further reducing the overheads.

In some embodiments, the mapping, based on quasi co-location QCL type information of the plurality of antenna ports, pilots corresponding to antenna ports having a QCL relationship to a first pilot resource block for transmission includes:
determining, based on a size of a pilot guard band, the first pilot resource block in the at least one pilot resource block, where the size of the pilot guard band is determined based on target QCL type information of the antenna ports having the QCL relationship; and
mapping the antenna ports having the QCL relationship to the first pilot resource block for transmission.

In some embodiments, for a group of antenna ports having a QCL relationship, based on target QCL type information of this group of antenna ports, a size of a guard band of a pilot resource block to which pilots of this group of antenna ports may be mapped may be determined, and in the at least one pilot resource block previously determined, an appropriate pilot resource block may be matched to serve as a first pilot resource block of this group of antenna ports having the QCL relationship, and then the pilots of this group of antenna ports having the QCL relationship are transmitted on the first pilot resource block.

In some embodiments, antenna ports may be first grouped. Antenna ports having a QCL relationship are classified into one group. For example, pilots/antenna ports having the same QCL relationship may share one pilot resource block, that is, be classified into one group. When determining a first pilot resource block, a size of a pilot guard band may be calculated based on target QCL type information of this group of antenna ports, and the first pilot resource block may be determined accordingly.

In some embodiments, the size of the pilot guard band includes: a width of the pilot guard band in a Doppler domain and a width of the pilot guard band in a delay domain, where
the width of the pilot guard band in the Doppler domain is determined based on Doppler shift information in the target QCL type information; and
the width of the pilot guard band in the delay domain is determined based on delay information in the target QCL type information.

In some embodiments, when determining the size of the pilot guard band, the width of the pilot guard band in the Doppler domain and the width of the pilot guard band in the delay domain may be determined.

In some embodiments, in the QCL relationship, types related to a delay and Doppler shift feature of a channel mainly include QCL-TypeA and QCL-TypeC, and the size of the pilot guard band may be determined according to delay information, average delay, and Doppler shift information, a Doppler shift value.

In some embodiments, the width of the pilot guard band in the Doppler domain may be obtained according to the Doppler shift information in the target QCL type information of the antenna ports having the QCL relationship.

In some embodiments, the width of the pilot guard band in the delay domain may be obtained according to the delay information in the target QCL type information of the antenna ports having the QCL relationship.

In some embodiments, the width of the pilot guard band in the Doppler domain and the width of the pilot guard band in the delay domain may be obtained through calculation according to the target QCL type information of the antenna ports having the QCL relationship, so that a size of a required pilot guard interval may be calculated and a pilot resource block with an appropriate pilot guard band size may be matched.

In some embodiments, the size of the pilot guard band is determined based on maximum Doppler shift information and maximum delay information in the target QCL type information of the antenna ports having the QCL relationship.

In some embodiments, in terms of a pilot design, a resource range of the pilot guard band may depend on a maximum delay τₘₐₓ and a maximum Doppler shift vₘₐₓ of a channel.

In some embodiments, when performing resource multiplexing on pilots of different antenna ports, to ensure performance of each antenna port, a guard band range may be matched to a pilot having a worst channel (that is, a channel having the maximum τₘₐₓ and vₘₐₓ).

In some embodiments, if pilots of channels that have similar delay and Doppler (pilots corresponding to antenna ports having a QCL relationship) are reused on a same pilot resource, for all antenna ports, their shared widths of pilot guard bands are not redundant and can avoid interference between the pilots and data.

In some embodiments, when determining the pilot guard band interval, vₘₐₓ=max{v^{max}ᵢ} and τₘₐₓ=max{m*τ^{a}}, m=1, 2, 3, or τₘₐₓ=max {τ^{a}ᵢ}+Δτ′, or max may be taken, thereby ensuring that the pilot guard band interval is large enough to avoid interference with data.

In some embodiments, according to the types related to the delay and Doppler shift feature of the channel in the QCL relationship, for example, an average delay and a Doppler shift value in the QCL-TypeA and in the QCL-TypeC, τₘₐₓ and vₘₐₓ may be calculated, and the size of the pilot guard band may be determined.

In some embodiments, the size of the pilot guard band is determined based on average Doppler shift information and average delay information in the target QCL type information of the antenna ports having the QCL relationship.

In some embodiments, in some special scenarios, to reduce pilot overheads, pilots and data of a received signal may be allowed to be non-orthogonal. In this case, the average Doppler shift information and the average delay information in the target QCL type information, that is, vₘₐₓ=mean{v^{max}ᵢ} and τₘₐₓ=mean{τ^{a}ᵢ}, of the antenna ports having the QCL relationship may be taken.

In some embodiments, vₘₐₓ=A *mean{v^{max}ᵢ} and τₘₐₓ=B*mean{τ^{max}ᵢ} may also be taken,
where A and B are scale factors used for flexibly adjusting the pilot overheads.

In some embodiments, the target QCL type information is determined based on a protocol.

In some embodiments, the target QCL type information may be determined based on a protocol. For example, type information of the QCL-TypeA that is specified in a protocol includes: a Doppler shift, Doppler spread, an average delay, delay spread.

For example, type information of the QCL-TypeC that is specified in a protocol includes: the Average delay and the Doppler shift.

In some embodiments, the target QCL type information includes: QCL-TypeA type information, QCL-TypeC type information, or QCL-TypeE type information.

In some embodiments, QCL types may include, but are not limited to: QCL-TypeA, QCL-TypeC, or QCL-TypeE.

The target QCL type information includes, but is not limited to: the QCL-TypeA type information, the QCL-TypeC type information, or the QCL-TypeE type information.

An example in which QCL type information includes the QCL-TypeA type information is used, and antenna port resource mapping is performed according to the QCL-TypeA. The guard band size in a Doppler dimension is determined by the Doppler shift information, and the guard band size in a delay dimension is determined by the average delay information.

For example, assuming that a maximum Doppler shift and an average delay of each of K antenna ports {Aᵢ, i=1, 2, . . . , K} that conform to a QCL-TypeA relationship are {v^{max}ᵢ, i=1, 2, . . . , K} and {τ^{a}ᵢ, i=1, 2, . . . , K} respectively, l_{τ},kᵥ is calculated according to l_{τ}≥τₘₐₓMΔf,kᵥ≥vₘₐₓNΔT. That is, when determining the guard band interval, vₘₐₓ=max{v^{max}ᵢ} and τₘₐₓ=max{m*τ^{a}ᵢ}, m=1, 2, 3, or τₘₐₓ=max{τ^{a}ᵢ}+Δτ′ may be taken, thereby ensuring that the pilot guard band interval is large enough to avoid interference with data.

For example, in some special scenarios, to reduce pilot overheads, pilots and data of a received signal may be allowed to be non-orthogonal. In this case, vₘₐₓ=mean{v^{max}ᵢ} and τₘₐₓ=mean{τ^{a}ᵢ} may be taken.

An example in which QCL type information includes the QCL-TypeC type information is used, and antenna port resource mapping is performed according to the QCL-TypeC. The guard band size in a Doppler dimension is determined by the Doppler shift information, and the guard band size in a delay dimension is determined by the average delay information.

For example, assuming that a maximum Doppler shift and an average delay of each of K antenna ports {Aᵢ, i=1, 2 . . . , K} that conform to a QCL-TypeC relationship are {v^{max}ᵢ, i=1, 2, . . . , K} and {τ^{a}ᵢ, i=1, 2, . . . , K} respectively, l_{τ},kᵥ is calculated according to l_{τ}≥τₘₐₓMΔf,kᵥ≥vₘₐₓNΔT. That is, when determining the guard band interval, vₘₐₓ=max {v^{max}ᵢ} and max={m*τ^{a}ᵢ}, m=1, 2, 3, or τₘₐₓ=max{τ^{a}ᵢ}+Δτ′ or max may be taken, thereby ensuring that the pilot guard band interval is large enough to avoid interference with data.

For example, in some special scenarios, to reduce pilot overheads, pilots and data of a received signal may be allowed to be non-orthogonal. In this case, vₘₐₓ=mean{v^{max}ᵢ} and τₘₐₓ=mean{τ^{a}ᵢ} may be taken.

In some embodiments, a new QCL type, that is, QCL-TypeE, used in the delay-Doppler domain may be defined, and may be used for more intuitively reflecting statistical features of a maximum delay and a maximum Doppler. Description of the QCL-TypeE is as shown in the following table 1:

TABLE 1
QCL-TypeE definition

| QCL Type | Description |
|---|---|
| QCL-TypeE | Maximum Doppler, Maximum delay |

In some embodiments, the QCL-TypeE type information includes: maximum Doppler shift information and maximum delay information.

In some embodiments, the QCL-TypeE type information may include the Maximum Doppler and the Maximum delay.

In some embodiments, the size of the pilot guard band is determined based on the maximum Doppler shift information and the maximum delay information in the QCL-TypeE type information.

In some embodiments, the QCL-TypeE type information may include the Maximum Doppler and the Maximum delay, that is, the maximum Doppler shift information and the maximum delay information. Therefore, when calculating a size of a pilot guard band of antenna ports or an antenna port group that has a QCL relationship and a QCL type of the QCL-TypeE, calculation may be directly performed based on the maximum Doppler shift information and the maximum delay information in the QCL-TypeE type information, to ensure that the pilot guard band interval is large enough to avoid interference with data. In addition, a step of obtaining the maximum Doppler shift information and the maximum delay information by calculation based on the Doppler shift, the Doppler spread, the average delay, and the delay spread or based on the average delay and the Doppler shift may also be omitted.

In the QCL-TypeE, pilot sequences corresponding to antenna ports with similar maximum Doppler and maximum delay are assigned to a same group and mapped to a same pilot resource block.

For example, assuming that a maximum Doppler shift and an average delay of each of K antenna ports {Aᵢ, i=1, 2 . . . , K} that conform to a QCL-TypeE relationship are {v^{max}ᵢ, i=1, 2, . . . , K} and {τ^{max}ᵢ, i=1, 2, . . . , K} respectively, l_{τ},kᵥ is calculated according to l_{τ}≥τₘₐₓMΔf,kᵥ≥vₘₐₓNΔT. That is, when determining the guard band interval, vₘₐₓ=max{v^{max}ᵢ} and τₘₐₓ=max{τ^{max}ᵢ} may be taken, thereby ensuring that the pilot guard band interval is large enough to avoid interference with data. For another example, in some special scenarios, to reduce pilot overheads, pilots and data of a received signal may be allowed to be non-orthogonal. In this case, vₘₐₓ=mean{v^{max}ᵢ} and τₘₐₓ=mean{τ^{a}ᵢ} may be taken.

In some embodiments, vₘₐₓ=A*mean{v^{max}ᵢ} τₘₐₓ=B*mean{τ^{max}^{ᵢ}} may also be taken,
where A and B are scale factors used for flexibly adjusting the pilot overheads.

In some embodiments, the determining at least one pilot resource block in a delay-Doppler domain includes:
determining, based on pilot resource block configuration information, coordinates and sizes of pilot guard bands of the at least one pilot resource block in the delay-Doppler domain.

In some embodiments, when determining the at least one pilot resource block in the delay-Doppler domain, a pilot of an antenna port may only determine the first pilot resource block of the antenna port by matching the size of the pilot guard band corresponding to the pilot itself with guard band sizes of the at least one pilot resource block. In addition, coordinates of the at least one pilot resource block may be determined to ensure more accurate mapping.

Therefore, based on the pilot resource block configuration information, the coordinates and sizes of the pilot guard bands of the at least one pilot resource block in the delay-Doppler domain may be determined.

In some embodiments, the pilot resource block configuration information may be used for indicating a number and mapping locations of pilot resource blocks. For example, a position of a jₜₕ pilot resource block in a currently processed delay-Doppler domain resource grid is represented by (kⱼ,lⱼ), where kⱼ is a coordinate of a delay-Doppler resource grid in a delay dimension, and lⱼ is a coordinate of the delay-Doppler resource grid in a Doppler dimension.

In some embodiments, the pilot resource block configuration information may be used for indicating the sizes of the pilot guard bands, which is represented by (gⱼ^{τ},gⱼ^{v}), where gⱼ^{τ} is a guard band width of a delay-Doppler resource grid in a delay dimension, and a unit may be a number of resource grids or a physical time unit. gⱼ^{v} is a guard band width of the delay-Doppler resource grid in a Doppler dimension, and a unit may be a number of resource grids or a physical frequency unit.

In some embodiments, a combination (kⱼ,lⱼ,gⱼ^{τ},gⱼ^{v}) of the coordinates and sizes of the pilot guard bands in the delay-Doppler domain may be used for uniquely determining a pilot resource block mapping mode.

For example, FIG. 13 is a schematic diagram of pilot resource block configuration according to an embodiment of this application. As shown in FIG. 13, in the delay-Doppler domain, two pilot resource blocks are configured by {(3,13,1,1),(11,4,2,2)}.

On this basis, vₘₐₓ and τₘₐₓ may be obtained by calculation according to channel feature statistical information or target QCL type information of each antenna port group, thereby calculating a size of a required pilot guard interval and matching a nearest combination of (kⱼ,lⱼ,gⱼ^{τ},gⱼ^{v}).

It may be understood that, the number and the mapping locations of the pilot resource blocks, and the sizes of the pilot guard bands may be protocol-preset.

In some embodiments, the determining coordinates of the at least one pilot resource block in the delay-Doppler domain includes:
determining coordinates of a target resource block in a delay domain and in a Doppler domain.

In some embodiments, the coordinates of the target resource block in the delay domain and in the Doppler domain may be determined.

For example, a position of a jₜₕ pilot resource block in a currently processed delay-Doppler domain resource grid may be represented by (kⱼ,lⱼ), where kⱼ is a coordinate of a delay-Doppler resource grid in a delay dimension, and lⱼ is a coordinate of the delay-Doppler resource grid in a Doppler dimension.

In some embodiments, the determining sizes of pilot guard bands of the at least one pilot resource block in the delay-Doppler domain includes:
determining a width of a pilot guard band of a target resource block in a delay domain and a width of the pilot guard band of the target resource block in a Doppler domain.

In some embodiments, the width of the pilot guard band of the target resource block in the delay domain and the guard band width of the pilot guard band of the target resource block in the Doppler domain may be determined.

In some embodiments, the size of the pilot guard band is represented by (gⱼ^{τ},gⱼ^{v}), where gⱼ^{τ} is a guard band width of a delay-Doppler resource grid in a delay dimension, and gⱼ^{v} is a guard band width of the delay-Doppler resource grid in a Doppler dimension. Therefore, the width of the pilot guard band of the target resource block in the delay domain and the width of the pilot guard band of the target resource block in the Doppler domain may be first determined.

In some embodiments, the method further includes:
remapping, based on channel quality-related information of a pilot resource block corresponding to an antenna port, a pilot corresponding to the antenna port to a second pilot resource block.

In some embodiments, each antenna port may determine, according to channel quality-related information periodically sent by a UE for each antenna port, whether a pilot resource block at which a pilot is currently located satisfies a requirement.

In some embodiments, if a channel measurement result of a pilot resource block corresponding to a certain antenna port is determined to have poor quality, it may be considered that the pilot is interfered by data due to insufficient pilot guard intervals. In this case, the antenna pilot corresponding to the antenna port may be remapped to the channel quality-related information, to reduce the interference received by the pilot at the receive end.

In some embodiments, if a channel measurement result of a pilot corresponding to a certain antenna port is determined to have poor quality, a special re-measurement process may be activated for the port, and according to a measurement result, the antenna pilot is reassigned to another group, that is, mapped to another pilot resource block. When an existing another group and the UE cannot satisfy a QCL condition, a new group needs to be established for the UE.

(1) The group information may be:
(a) a selected group of pilot resource block configurations that are protocol-preconfigured; or
(b) determined by a measurement method. Signals that may be used for measurement include an SSB and another reference signal. During the measurement, a pilot signal block corresponding to each antenna port may be in a form of resource orthogonality and have sufficient guard intervals left to ensure measurement accuracy.

In some embodiments, before the remapping, a pilot corresponding to the antenna port to a second pilot resource block, the method further includes:
determining the second pilot resource block in the at least one pilot resource block; or,
re-determining, in a case that the at least one pilot resource block does not include the second pilot resource block, the at least one pilot resource block in the delay-Doppler domain, where
a size of a pilot guard band of the second pilot resource block is greater than a size of a pilot guard band of a first pilot resource block.

In some embodiments, the antenna pilot may be remapped to another pilot resource block with a greater pilot guard interval, to reduce the interference received by the pilot at the receive end.

In some embodiments, the second pilot resource block with a greater pilot guard band may be selected from the at least one pilot resource block determined previously, and may be used for remapping a pilot, where a current pilot resource block at which the pilot is located does not satisfy a requirement.

In some embodiments, the second pilot resource block is directly determined from the at least one pilot resource block, and grouping does not need to be re-activated, that is, pilot resource blocks do not need to be reassigned, and the process is simple.

In some embodiments, a pilot port may be triggered for remapping, re-determining the at least one pilot resource block and remapping. For example, when a pilot resource block that satisfies a condition cannot be found, the pilot port is triggered for remapping, for example, re-selecting (kⱼ,lⱼ,gⱼ^{τ},gⱼ^{v}) of a group of pilot resource blocks that satisfy the condition according to a process of re-determining the at least one pilot resource block.

In some embodiments, the method further includes:
mapping, based on channel quality-related information of a pilot resource block corresponding to the plurality of antenna ports, pilots corresponding to antenna ports having a QCL relationship to a third pilot resource block for transmission.

In some embodiments, before sending a pilot signal of the delay-Doppler domain for channel estimation, a number of other signals such as an SSB, a TRS, and a channel state information reference signal (CSI-RS), with measurement functions may be sent. These signals may be periodically or semi-statically configured with less overheads than the pilot signal. Through measurement of the foregoing signals, although an accurate channel matrix cannot be obtained, very useful channel statistical features can be obtained, to provide a reference for a design and mapping of the pilot signal of the delay-Doppler domain.

An embodiment of this application provides a configurable antenna port grouping scheme implemented close to a protocol. Assuming that a number of antenna ports is N, antenna port group information may be first initialized at the beginning of a process. Initialization of antenna port grouping is determined by using a measurement-assisted method.

In some embodiments, initial antenna port grouping is determined by a base station, and correspondingly, may be determined by using a measurement result based on an uplink pilot or a downlink pilot when a pilot resource block starts to send a pilot.

In some embodiments, when the base station determines the antenna port grouping and a mapping manner through channel measurement, these information may be indicated to a UE so that the UE obtains a pilot sequence at a correct location to help data demodulation and decoding.

In some embodiments, based on channel quality-related information of a pilot resource block corresponding to a plurality of antenna ports, pilots corresponding to antenna ports having a QCL relationship are mapped to a third pilot resource block for transmission, and a plurality of pilot sequences are implemented to be mapped to a plurality of pilot resource blocks, where the mapping manner may be determined based on a rule. In addition, flexible adjustment may be performed according to a channel state change.

When re-configuration is performed due to the channel state change, each antenna port may be respectively measured. When a number of ports is large, an RX-Feedback-based measurement process brings high resource overheads and delay.

Therefore, it is also possible that a channel measurement result of a pilot resource block corresponding to only a certain antenna port is determined to have poor quality, and then the antenna port is remapped.

In some embodiments, the mapping, based on channel quality-related information of a pilot resource block corresponding to the plurality of antenna ports, pilots corresponding to antenna ports having a QCL relationship to a third pilot resource block for transmission includes:
determining, for a target antenna port based on a size of a third pilot guard band, the third pilot resource block corresponding to the target antenna port in the at least one pilot resource block, where the size of the third pilot guard band is determined based on channel quality-related information of a pilot resource block corresponding to the target antenna port; and

mapping the target antenna port to the corresponding third pilot resource block for transmission.

An embodiment of this application provides a configurable antenna port grouping scheme for different scenarios. When a rule that a group of antenna ports with similar channel statistical features reuse one pilot resource block is used, numbers of pilot resource blocks required for different antenna ports to be grouped are also different. Therefore, a flexible pilot resource block configuration manner may be further introduced to obtain a trade-off between performance and overheads.

In some embodiments, for a pilot-to-be-mapped target antenna port, based on channel quality-related information of the target antenna port, a guard band size of a pilot resource block to which a pilot of the target antenna port may be mapped may be determined, and in the at least one pilot resource block previously determined, an appropriate pilot resource block may be matched to serve as a third pilot resource block of the target antenna port, and then the pilot of the target antenna port is transmitted on the third pilot resource block.

In some embodiments, on this basis, vₘₐₓ and τₘₐₓ may be obtained by calculation according to channel feature statistical information of antenna ports having a QCL relationship, thereby calculating a size of a required pilot guard interval and matching a nearest combination of (kⱼ,lⱼ,gⱼ^{τ},gⱼ^{v}) in the predetermined at least one pilot resource block.

It may be understood that, the predetermined at least one pilot resource block may be protocol-preset.

In some embodiments, key parameters of channel estimation in the delay-Doppler domain are a delay and a Doppler shift of a channel.

In some embodiments, a width of a third guard band in a Doppler domain and a width of the third guard band in a delay domain may be obtained through calculation according to the channel quality-related information of the pilot-to-be-mapped target antenna port, so that the size of the required pilot guard interval may be calculated and a pilot resource block with an appropriate pilot guard band size may be matched.

In some embodiments, the channel quality-related information of the pilot resource block corresponding to the antenna port includes:

ACK/NACK information and a measurement report that is periodically sent by a terminal, where
the measurement report includes: signal to noise ratio information, signal delay information, Doppler shift information, and bit error rate information that are obtained through measurement by the terminal after receiving the pilot corresponding to the antenna port.
In some embodiments, the channel quality-related information of the pilot resource block corresponding to the antenna port may include acknowledgement (ACK) information/negative acknowledgement (NACK) information and the measurement report that is periodically sent by the terminal, where
the measurement report may include: the signal to noise ratio information, the signal delay information, the Doppler shift information, the bit error rate information, and the like that are obtained through measurement by the terminal after receiving the pilot corresponding to the antenna port.

In some embodiments, during measurement:
(1) sending of pilot block: a base station sends a pilot signal according to a determined mapping relationship between an antenna port and a pilot resource block;
(2) measurement and feedback: to handle a case that the channel may change, user equipment (UE), for example, the terminal, may periodically send the measurement report for each antenna port, where the measurement report may include: a received SNR of the pilot signal, a delay and a Doppler shift of the signal, a bit error rate, and the like; and
(3) reconfiguration: the base station may make a decision, that is, whether current antenna port grouping is reasonable, by synthesizing the measurement report of the UE and the existing feedback information, namely, the ACK/NACK information.

In some embodiments, the measurement report is obtained by the terminal based on quality of an uplink pilot measurement channel, or the measurement report is obtained by the terminal based on quality of a downlink pilot measurement channel.

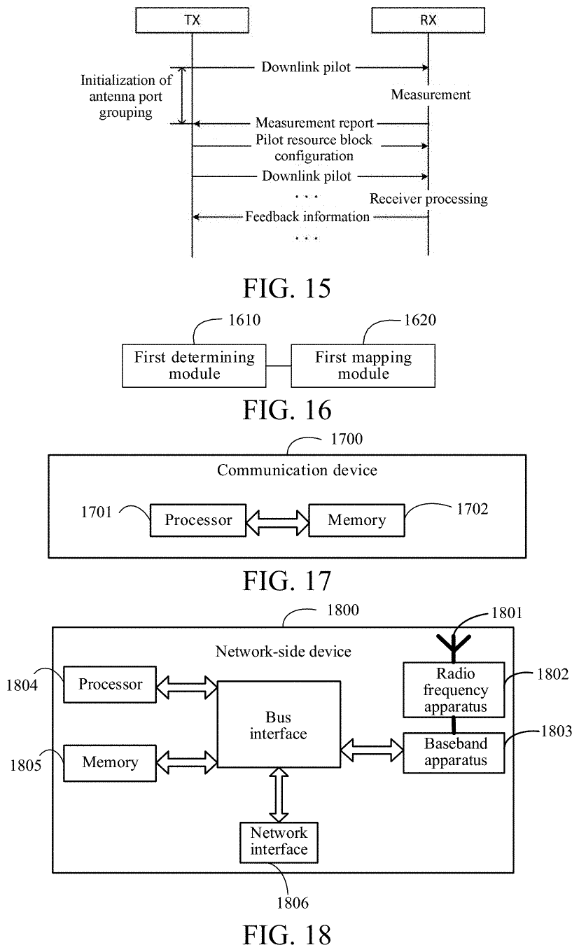

In some embodiments, FIG. 14 is a first schematic diagram of channel measurement according to an embodiment of this application, and FIG. 15 is a second schematic diagram of channel measurement according to an embodiment of this application. As shown in FIG. 14 and FIG. 15, an antenna port may use measurement based on an uplink pilot or a downlink pilot to obtain a measurement report.

In some embodiments, the uplink pilot may be sent by a terminal, and a base station performs measurement based on the received uplink pilot to obtain the measurement report, and may also combine feedback information to perform pilot resource block configuration and inform the terminal.

In some embodiments, the downlink pilot may be sent by the base station, and the terminal performs measurement based on the received downlink pilot to obtain the measurement report and send the measurement report to the base station. The base station combines the feedback information based on the measurement report to perform pilot resource block configuration and inform the terminal.

In some embodiments, channel measurement of each antenna port may be performed first, which may be performed through cooperation of a transmit end and a receive end, involving a process of sending, measuring and feeding back a series of pilot signals. When a number of antenna ports is large, resource occupation overheads and a delay caused by this process are objective.

In some embodiments, the method further includes:
sending the pilot resource block configuration information to a terminal by using first indication information.

In some embodiments, the pilot resource block configuration information may be used for determining coordinates and sizes of pilot guard bands of the at least one pilot resource block in the delay-Doppler domain. Therefore, the pilot resource block configuration information may be sent to the terminal by using the first indication information, so that the terminal can better demodulate a received signal.

In some embodiments, the first indication information is carried by downlink control information DCI or radio resource control information RRC, or, the first indication information is carried in a physical downlink control channel PDCCH or a physical downlink shared channel PDSCH.

In some embodiments, the base station selects a configuration based on the pilot resource block configuration information, which facilitates indicating an index of the configuration to a UE through the downlink control information (DCI) or a radio resource control (RRC) message, or, indicating an index of the configuration in the physical downlink control channel (PDCCH) or the physical downlink shared channel (PDSCH) to a UE, to reduce overheads.

In some embodiments, the first indication information includes:
the pilot resource block configuration information; or,
index information, where the index information is used for indicating pilot resource block configuration information in a predefined pilot resource block configuration table.

In some embodiments, the pilot resource block configuration information may be directly sent to the terminal, for example, a piece of combination information “8 antenna ports are currently configured, there are two pilot resource blocks which are located at (k₀, l₀) and (k₁, l₁) respectively, and a guard interval is (g₁^{τ}, g₁^{v})” may be directly sent.

In some embodiments, the index information used for indicating the pilot resource block configuration information in the predefined pilot resource block configuration table may be directly sent to the terminal.

A protocol may specify two groups of preset tables, that is, a pilot resource block mapping location table and a pilot guard band value table, to implement a more simplified antenna port grouping mapping scheme, which can minimize feedback overheads and delay, and simplify protocol configuration.

For example, a pilot resource block configuration table may be predefined by using a protocol. As shown in FIG. 2, configuration in the table may be selected according to an antenna port number.

TABLE 2
Pilot resource block configuration table

| Antenna port | Pilot sequence | |
|---|---|---|
| number | mapping location | Guard interval |
| 1 | (k₀¹, l₀¹) | (g₀^{τ}, g₀^{ν}), (g₁^{τ}, g₁^{ν}) |
| 2 | (k₀², l₀²) | (g₀^{τ}, g₀^{ν}), (g₁^{τ}, g₁^{ν}) |
| 4 | (k₀⁴, l₀⁴) | (g₀^{τ}, g₀^{ν}), (g₁^{τ}, g₁^{ν}) |
| 8 | (k₀⁸, l₀⁸) | (g₀^{τ}, g₀^{ν}), (g₁^{τ}, g₁^{ν}), |
| | (k₀⁸, l₀⁸), (k₁⁸, l₁⁸) | (g₂^{τ}, g₂^{ν}), (g₃^{τ}, g₃^{ν}) |
| 16 | (k₀¹⁶, l₀¹⁶) | (g₀^{τ}, g₀^{ν}), (g₁^{τ}, g₁^{ν}), |
| | (k₀¹⁶, l₀¹⁶), (k₁¹⁶, l₁¹⁶) | (g₂^{τ}, g₂^{ν}), (g₃^{τ}, g₃^{ν}) |
| | (k₀¹⁶, l₀¹⁶), (k₁¹⁶, l₁¹⁶), | |
| | (k₂¹⁶, l₂¹⁶), (k₃¹⁶, l₃¹⁶) | |
| 24 | (k₀¹⁶, l₀¹⁶) | (g₀^{τ}, g₀^{ν}), (g₁^{τ}, g₁^{ν}), |
| | (k₀¹⁶, l₀¹⁶), (k₁¹⁶, l₁¹⁶) | (g₂^{τ}, g₂^{ν}), (g₃^{τ}, g₃^{ν}) |
| | (k₀¹⁶, l₀¹⁶), (k₁¹⁶, l₁¹⁶), | |
| | (k₂¹⁶, l₂¹⁶), (k₃¹⁶, l₃¹⁶) | |
| . . . | . . . | |

In some embodiments, the pilot resource block configuration table is known to the transmit end and the receive end. When the base station selects configuration, for example, indicating (4, 2, 2), it represents that 8 antenna ports are currently configured, there are two pilot resource blocks which are located at (k₀,l₀) and (k₁,l₁) respectively, and the guard interval is (g₁^{τ}, g₁^{v}).

In some embodiments, the method further includes:
sending the pilot resource block configuration table to the terminal by using second indication information.

In some embodiments, the base station may send the pilot resource block configuration table to the terminal by using second indication information, to ensure that both the transmit end and the receive end know the pilot resource block configuration table.

In some embodiments, when a plurality of tables are configured, the base station may inform the terminal of a table used in a current cell by using the second indication information.

In some embodiments, the second indication information is carried by a master information block MIB or a system information block SIB, or, the second indication information is carried in a physical broadcast channel PBCH or a PDSCH.

In some embodiments, the base station may broadcast the table used in the current cell by using the master information block (MIB) or the system information block (SIB), or the table used in the current cell may be carried by a physical broadcast channel (PBCH) or a physical downlink share channel (PDSCH), and then an index of a configuration in the PDCCH or PDSCH are indicated to the UE by using DCI or a radio resource control (RRC) message.

In some embodiments, the mapping pilots corresponding to a plurality of antenna ports to the at least one pilot resource block for transmission includes:
mapping pilots corresponding to antenna ports that do not have the QCL relationship to different pilot resource blocks for transmission, where
sizes of pilot guard bands of the different pilot resource blocks are the same or different.

In some embodiments, for antenna ports having different QCL relationships, during pilot mapping, sizes of corresponding pilot guard intervals may be different or may be the same.

In some embodiments, antenna ports having a same QCL relationship are mapped to a same pilot resource block, the antenna ports that do not the QCL relationship are mapped to different pilot resource blocks, and the sizes of the pilot guard bands (that is, guard intervals) of the different pilot resource blocks may be the same or different.

In some embodiments, the mapping pilots corresponding to a plurality of antenna ports to the at least one pilot resource block for transmission includes:

making resources occupied by the pilots corresponding to the plurality of antenna ports orthogonal or non-orthogonal.

In some embodiments, pilot sequences corresponding to multi-antenna ports are mapped to a delay-Doppler resource grid in a manner of combining an orthogonal mapping manner and a non-orthogonal mapping manner.

For example, pilots corresponding to antenna ports mapped to a same pilot resource block are orthogonal, and pilots corresponding to antenna ports mapped to different pilot resource blocks are non-orthogonal.

In the embodiments of this application, by mapping pilots corresponding to a plurality of antenna ports to at least one pilot resource block in a delay-Doppler domain for transmission, a defect of high resource overheads caused by a single-point pilot mapping manner is avoided, a defect of detection performance reduction and high complexity caused by constructing the pilots corresponding to the plurality of antenna ports into a pilot sequence through a PN sequence is also avoided, and pilot overheads in a multi-antenna port system can be reduced. In addition, reliability of system performance is ensured.

It is to be noted that, the pilot transmission method according to this embodiment of this application may be performed by a pilot transmission apparatus, or, a control module configured to perform the pilot transmission method in the pilot transmission apparatus. An example in which the pilot transmission apparatus performs the pilot transmission method is used in the embodiments of this application to describe the pilot transmission apparatus according to the embodiments of this application.

FIG. 16 is a schematic structural diagram of a pilot transmission apparatus according to an embodiment of this application. As shown in FIG. 16, the apparatus is applied to a network-side device, and includes the following modules: a first determining module 1610 and a first mapping module 1620.

The first determining module 1610 is configured to determine at least one pilot resource block in a delay-Doppler domain.

The first mapping module 1620 is configured to map pilots corresponding to a plurality of antenna ports to the at least one pilot resource block for transmission.

A pilot corresponding to one antenna port is mapped to one pilot resource block in the at least one pilot resource block.

In some embodiments, the pilot transmission apparatus may determine the at least one pilot resource block in the delay-Doppler domain by using the first determining module 1610, and then map the pilots corresponding to the plurality of antenna ports to the at least one pilot resource block for transmission by using the first mapping module 1620.

It is to be noted that, the foregoing apparatus according to this embodiment of this application can implement all the method steps implemented by the foregoing pilot transmission method embodiments, and the same technical effects can be achieved. Same parts as the method embodiments and beneficial effects in this embodiment are not described in detail herein again.

In the embodiments of this application, by mapping pilots corresponding to a plurality of antenna ports to at least one pilot resource block in a delay-Doppler domain for transmission, a defect of high resource overheads caused by a single-point pilot mapping manner is avoided, a defect of detection performance reduction and high complexity caused by constructing the pilots corresponding to the plurality of antenna ports into a pilot sequence through a PN sequence is also avoided, and pilot overheads in a multi-antenna port system can be reduced. In addition, reliability of system performance is ensured.

In some embodiments, the first mapping module is further configured to:
map, based on quasi co-location QCL type information of the plurality of antenna ports, pilots corresponding to antenna ports having a QCL relationship to a first pilot resource block for transmission.

In some embodiments, the first mapping module is further configured to:
determine, based on a size of a pilot guard band, the first pilot resource block in the at least one pilot resource block, where the size of the pilot guard band is determined based on target QCL type information of the antenna ports having the QCL relationship; and
map the antenna ports having the QCL relationship to the first pilot resource block for transmission.

In some embodiments, the size of the pilot guard band includes: a width of the pilot guard band in a Doppler domain and a width of the pilot guard band in a delay domain, where
the width of the pilot guard band in the Doppler domain is determined based on Doppler shift information in the target QCL type information; and
the width of the pilot guard band in the delay domain is determined based on delay information in the target QCL type information.

In some embodiments, the size of the pilot guard band is determined based on maximum Doppler shift information and maximum delay information in the target QCL type information of the antenna ports having the QCL relationship.

In some embodiments, the size of the pilot guard band is determined based on average Doppler shift information and average delay information in the target QCL type information of the antenna ports having the QCL relationship.

In some embodiments, the target QCL type information is determined based on a protocol.

In some embodiments, the target QCL type information includes: QCL-TypeA type information, QCL-TypeC type information, or QCL-TypeE type information.

In some embodiments, the QCL-TypeE type information includes: maximum Doppler shift information and maximum delay information.

In some embodiments, the size of the pilot guard band is determined based on the maximum Doppler shift information and the maximum delay information in the QCL-TypeE type information.

In some embodiments, the first determining module is further configured to:
determine, based on pilot resource block configuration information, coordinates and sizes of pilot guard bands of the at least one pilot resource block in the delay-Doppler domain.

In some embodiments, the first determining module is further configured to:
determine coordinates of a target resource block in a delay domain and in a Doppler domain.

In some embodiments, the first determining module is further configured to:
determine a width of a pilot guard band of a target resource block in a delay domain and a width of the pilot guard band of the target resource block in a Doppler domain.

In some embodiments, the apparatus further includes:
a second mapping module, configured to remap, based on channel quality-related information of a pilot resource block corresponding to an antenna port, a pilot corresponding to the antenna port to a second pilot resource block.

In some embodiments, the apparatus further includes:
a second determining module, configured to determine the second pilot resource block in the at least one pilot resource block; or,
a third determining module, configured to re-determine, in a case that the at least one pilot resource block does not include the second pilot resource block, the at least one pilot resource block in the delay-Doppler domain, where
a size of a pilot guard band of the second pilot resource block is greater than a size of a pilot guard band of a first pilot resource block.

In some embodiments, the apparatus further includes:
a third mapping module, configured to map, based on channel quality-related information of a pilot resource block corresponding to the plurality of antenna ports, pilots corresponding to antenna ports having a QCL relationship to a third pilot resource block for transmission.

In some embodiments, the third mapping module is further configured to:
determine, for a target antenna port based on a size of a third pilot guard band, the third pilot resource block corresponding to the target antenna port in the at least one pilot resource block, where the size of the third pilot guard band is determined based on channel quality-related information of a pilot resource block corresponding to the target antenna port; and
map the target antenna port to the corresponding third pilot resource block for transmission.

In some embodiments, the channel quality-related information of the pilot resource block corresponding to the antenna port includes:
ACK/NACK information and a measurement report that is periodically sent by a terminal, where
the measurement report includes: signal to noise ratio information, signal delay information, Doppler shift information, and bit error rate information that are obtained through measurement by the terminal after receiving the pilot corresponding to the antenna port.

In some embodiments, the measurement report is obtained by the terminal based on quality of an uplink pilot measurement channel, or the measurement report is obtained by the terminal based on quality of a downlink pilot measurement channel.

In some embodiments, the apparatus further includes:
a first sending module, configured to send the pilot resource block configuration information to a terminal by using first indication information.

In some embodiments, the first indication information is carried by downlink control information DCI or radio resource control RRC information, or, the first indication information is carried in a physical downlink control channel PDCCH or a physical downlink shared channel PDSCH.

In some embodiments, the first indication information includes:
the pilot resource block configuration information; or,
index information, where the index information is used for indicating pilot resource block configuration information in a predefined pilot resource block configuration table.

In some embodiments, the apparatus further includes:

a second sending module, configured to send the pilot resource block configuration table to the terminal by using second indication information.

In some embodiments, the second indication information is carried by a master information block MIB or a system information block SIB, or, the second indication information is carried in a physical broadcast channel PBCH or a PDSCH.

In some embodiments, the first mapping module is further configured to:

map pilots corresponding to antenna ports that do not have the QCL relationship to different pilot resource blocks for transmission, where

sizes of pilot guard bands of the different pilot resource blocks are the same or different.

In some embodiments, the first mapping module is further configured to:

make resources occupied by the pilots corresponding to the plurality of antenna ports orthogonal or non-orthogonal.

The pilot transmission apparatus in this embodiment of this application may be an apparatus, or may be a component, an integrated circuit, or a chip in a terminal. The apparatus may be a mobile terminal or may be a non-mobile terminal. Exemplarily, the mobile terminal may include but is not limited to the category of the terminal 11 listed above. The non-mobile terminal may be a server, a network attached storage (Network Attached Storage, NAS), a personal computer (personal computer, PC), a television (television, TV), a teller machine, a self-service machine, or the like, which is not specifically limited in this embodiment of this application.

The pilot transmission apparatus in this embodiment of this application may be an apparatus with an operating system. The operating system may be an Android (Android) operating system, an ios operating system, or another possible operating system, which is not specifically limited in this embodiment of this application.

The pilot transmission apparatus according to this embodiment of this application can implement all processes implemented by the method embodiments shown in FIG. 1 to FIG. 15, and the same technical effects can be achieved. Details are not described herein again to avoid repetition.

In some embodiments, FIG. 17 is a schematic structural diagram of a communication device according to an embodiment of this application. As shown in FIG. 17, a communication device 1700 includes a processor 1701, a memory 1702, and a program or instructions stored in the memory 1702 and runnable on the processor 1701. For example, when the communication device 1700 is a terminal, when the program or instructions are executed by the processor 1701, each process of the foregoing pilot transmission method embodiments is implemented, and the same technical effects can be achieved. When the communication device 1700 is a network-side device, when the program or instructions are executed by the processor 1701, each process of the foregoing pilot transmission method embodiments is implemented, and the same technical effects can be achieved. Details are not described herein again to avoid repetition.

FIG. 18 is a schematic diagram of a hardware structure of a network-side device according to an embodiment of this application.

As shown in FIG. 18, the network-side device 1800 includes: an antenna 1801, a radio frequency apparatus 1802, and a baseband apparatus 1803. The antenna 1801 is connected to the radio frequency apparatus 1802. In an uplink direction, the radio frequency apparatus 1802 receives information through the antenna 1801 and sends the received information to the baseband apparatus 1803 for processing. In a downlink direction, the baseband apparatus 1803 processes the information to be sent and sends the processed information to the radio frequency apparatus 1802. The radio frequency apparatus 1802 processes the received information and sends the processed received information out through the antenna 1801.

The foregoing radio frequency apparatus may be located in the baseband apparatus 1803, and the method executed by the network-side device in the above embodiments may be implemented in the baseband apparatus 1803, where the baseband apparatus 1803 includes a processor 1804 and a memory 1805.

The baseband apparatus 1803 may, for example, include at least one baseband board, where a plurality of chips are disposed on the baseband board. As shown in FIG. 18, one of the chips is, for example, the processor 1804, connected with the memory 1805 to invoke a program in the memory 1805 to perform network device operations shown in the above method embodiments.

The baseband apparatus 1803 may further include a network interface 1806, configured to interact information with the radio frequency apparatus 1802, and the network interface is, for example, a common public radio interface (common public radio interface, referred to as CPRI for short).

In some embodiments, the network-side device of this embodiment of this application further includes: instructions or a program stored in the memory 1805 and runnable on the processor 1804, and the processor 1804 invokes the instructions or the program in the memory 1805 to perform the method performed by the modules shown in FIG. 16, and the same technical effects can be achieved. Therefore, details are not described herein again to avoid repetition.

The processor 1804 is configured to:
determine at least one pilot resource block in a delay-Doppler domain; and
map pilots corresponding to a plurality of antenna ports to the at least one pilot resource block for transmission, where
a pilot corresponding to one antenna port is mapped to one pilot resource block in the at least one pilot resource block.

In some embodiments, the processor 1804 is further configured to:
map, based on quasi co-location QCL type information of the plurality of antenna ports, pilots corresponding to antenna ports having a QCL relationship to a first pilot resource block for transmission.

In some embodiments, the processor 1804 is further configured to:
determine, based on a size of a pilot guard band, the first pilot resource block in the at least one pilot resource block, where the size of the pilot guard band is determined based on target QCL type information of the antenna ports having the QCL relationship; and
map the antenna ports having the QCL relationship to the first pilot resource block for transmission.

In some embodiments, the size of the pilot guard band includes: a width of the pilot guard band in a Doppler domain and a width of the pilot guard band in a delay domain, where
the width of the pilot guard band in the Doppler domain is determined based on Doppler shift information in the target QCL type information; and
the width of the pilot guard band in the delay domain is determined based on delay information in the target QCL type information.

In some embodiments, the size of the pilot guard band is determined based on maximum Doppler shift information and maximum delay information in the target QCL type information of the antenna ports having the QCL relationship.

In some embodiments, the size of the pilot guard band is determined based on average Doppler shift information and average delay information in the target QCL type information of the antenna ports having the QCL relationship.

In some embodiments, the target QCL type information is determined based on a protocol.

In some embodiments, the target QCL type information includes: QCL-TypeA type information, QCL-TypeC type information, or QCL-TypeE type information.

In some embodiments, the QCL-TypeE type information includes: maximum Doppler shift information and maximum delay information.

In some embodiments, the size of the pilot guard band is determined based on the maximum Doppler shift information and the maximum delay information in the QCL-TypeE type information.

In some embodiments, the processor 1804 is further configured to:
determine, based on pilot resource block configuration information, coordinates and sizes of pilot guard bands of the at least one pilot resource block in the delay-Doppler domain.

In some embodiments, the processor 1804 is further configured to:
determine coordinates of a target resource block in a delay domain and in a Doppler domain.

In some embodiments, the processor 1804 is further configured to:
determine a width of a pilot guard band of a target resource block in a delay domain and a width of the pilot guard band of the target resource block in a Doppler domain.

In some embodiments, the processor 1804 is further configured to:
remap, based on channel quality-related information of a pilot resource block corresponding to an antenna port, a pilot corresponding to the antenna port to a second pilot resource block.

In some embodiments, the processor 1804 is further configured to:
determine the second pilot resource block in the at least one pilot resource block; or,
re-determine, in a case that the at least one pilot resource block does not include the second pilot resource block, the at least one pilot resource block in the delay-Doppler domain, where
a size of a pilot guard band of the second pilot resource block is greater than a size of a pilot guard band of a first pilot resource block.

In some embodiments, the processor 1804 is further configured to:
map, based on channel quality-related information of a pilot resource block corresponding to the plurality of antenna ports, pilots corresponding to antenna ports having a QCL relationship to a third pilot resource block for transmission.

In some embodiments, the processor 1804 is further configured to:
determine, for a target antenna port based on a size of a third pilot guard band, the third pilot resource block corresponding to the target antenna port in the at least one pilot resource block, where the size of the third pilot guard band is determined based on channel quality-related information of a pilot resource block corresponding to the target antenna port; and
map the target antenna port to the corresponding third pilot resource block for transmission.

In some embodiments, the channel quality-related information of the pilot resource block corresponding to the antenna port includes:
ACK/NACK information and a measurement report that is periodically sent by a terminal, where
the measurement report includes: signal to noise ratio information, signal delay information, Doppler shift information, and bit error rate information that are obtained through measurement by the terminal after receiving the pilot corresponding to the antenna port.

In some embodiments, the measurement report is obtained by the terminal based on quality of an uplink pilot measurement channel, or the measurement report is obtained by the terminal based on quality of a downlink pilot measurement channel.

In some embodiments, the processor 1804 is further configured to:
send the pilot resource block configuration information to a terminal by using first indication information.

In some embodiments, the first indication information is carried by downlink control information DCI or radio resource control RRC information, or, the first indication information is carried in a physical downlink control channel PDCCH or a physical downlink shared channel PDSCH.

In some embodiments, the first indication information includes:
the pilot resource block configuration information; or,
index information, where the index information is used for indicating pilot resource block configuration information in a predefined pilot resource block configuration table.

In some embodiments, the processor 1804 is further configured to:
send the pilot resource block configuration table to the terminal by using second indication information.

In some embodiments, the second indication information is carried by a master information block MIB or a system information block SIB, or, the second indication information is carried in a physical broadcast channel PBCH or a PDSCH.

In some embodiments, the processor 1804 is further configured to:
map pilots corresponding to antenna ports that do not have the QCL relationship to different pilot resource blocks for transmission, where
sizes of pilot guard bands of the different pilot resource blocks are the same or different.

In some embodiments, the processor 1804 is further configured to:
make resources occupied by the pilots corresponding to the plurality of antenna ports orthogonal or non-orthogonal.

In the embodiments of this application, by mapping pilots corresponding to a plurality of antenna ports to at least one pilot resource block in a delay-Doppler domain for transmission, a defect of high resource overheads caused by a single-point pilot mapping manner is avoided, a defect of detection performance reduction and high complexity caused by constructing the pilots corresponding to the plurality of antenna ports into a pilot sequence through a PN sequence is also avoided, and pilot overheads in a multi-antenna port system can be reduced. In addition, reliability of system performance is ensured.

An embodiment of this application further provides a readable storage medium, storing a program or instructions, where when the program or instructions are executed by a processor, each process of the foregoing pilot transmission method embodiments is implemented and the same technical effects can be achieved. Details are not described herein again to avoid repetition.

The processor is the processor in the terminal described in the above embodiment. The readable storage medium includes a computer-readable storage medium, such as, a read-only memory (Read-Only Memory, ROM), a random access memory (Random Access Memory, RAM), a magnetic disk, or an optical disk.

An embodiment of this application further provides a chip, including a processor and a communication interface, where the communication interface is coupled to the processor, and the processor is configured to run a program or instructions of a network-side device to implement each process of the foregoing pilot transmission method embodiments and the same technical effects can be achieved. Details are not described herein again to avoid repetition.

It is to be understood that the chip mentioned in this embodiment of this application may also be referred to as a system-level chip, a system chip, a chip system, an SoC chip, or the like.

It is to be noted that, the term “comprise”, “include” or any other variation thereof in this specification is intended to cover a non-exclusive inclusion, which specifies the presence of stated processes, methods, objects, or apparatuses, but does not preclude the presence or addition of one or more other processes, methods, objects, or apparatuses. Without more limitations, elements defined by the sentence “including one” does not exclude that there are still other same elements in the process, method, object, or apparatus. In addition, it is to be noted that, the scope of the method and apparatus in the embodiments of this application is not limited to performing the functions in the order shown or discussed, but may also include performing the functions in a substantially simultaneous manner or in a reverse order according to the functions involved, for example, the described method may be performed in a sequence different from the described order, and various steps may also be added, omitted, or combined. In addition, features described with reference to certain examples may be combined in other examples.

Through the description of the foregoing implementations, a person skilled in the art may clearly understand that the method according to the foregoing embodiments may be implemented by means of software and a necessary general hardware platform, and certainly, may also be implemented by hardware, but in many cases, the former manner is a better implementation. Based on such an understanding, the technical solutions of this application essentially or the part contributing to the prior art may be implemented in a form of a software product. The computer software product is stored in a storage medium (such as a ROM/RAM, a magnetic disk, or an optical disk) and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific embodiments, which are merely illustrative rather than limited. Under the inspiration of this application, a person of ordinary skill in the art can make many forms without departing from the scope of this application and the protection of the claims, all of which fall within the protection of this application.

What is claimed is:

1. A pilot transmission method, comprising:
determining, by a network-side device, at least one pilot resource block in a delay-Doppler domain; and
mapping, by the network-side device, pilots corresponding to a plurality of antenna ports to the at least one pilot resource block for transmission, wherein
a pilot corresponding to one antenna port is mapped to one pilot resource block in the at least one pilot resource block.

2. The pilot transmission method according to claim 1, wherein the mapping, by the network-side device, pilots corresponding to a plurality of antenna ports to the at least one pilot resource block for transmission comprises:
mapping, by the network-side device based on quasi co-location QCL type information of the plurality of antenna ports, pilots corresponding to antenna ports having a QCL relationship to a first pilot resource block for transmission.

3. The pilot transmission method according to claim 2, wherein the mapping, by the network-side device based on quasi co-location QCL type information of the plurality of antenna ports, pilots corresponding to antenna ports having a QCL relationship to a first pilot resource block for transmission comprises:
determining, by the network-side device based on a size of a pilot guard band, the first pilot resource block in the at least one pilot resource block, wherein the size of the pilot guard band is determined based on target QCL type information of the antenna ports having the QCL relationship; and
mapping, by the network-side device, the antenna ports having the QCL relationship to the first pilot resource block for transmission.

4. The pilot transmission method according to claim 3, wherein the size of the pilot guard band comprises: a width of the pilot guard band in a Doppler domain and a width of the pilot guard band in a delay domain;
the width of the pilot guard band in the Doppler domain is determined based on Doppler shift information in the target QCL type information; and
the width of the pilot guard band in the delay domain is determined based on delay information in the target QCL type information.

5. The pilot transmission method according to claim 3, wherein the size of the pilot guard band is determined based on maximum Doppler shift information and maximum delay information in the target QCL type information of the antenna ports having the QCL relationship, or
wherein the size of the pilot guard band is determined based on average Doppler shift information and average delay information in the target QCL type information of the antenna ports having the QCL relationship.

6. The pilot transmission method according to claim 3, wherein the target QCL type information is determined based on a protocol;
wherein the target QCL type information comprises: QCL-TypeA type information, QCL-TypeC type information, or QCL-TypeE type information;
wherein the QCL-TypeE type information comprises: maximum Doppler shift information and maximum delay information;
wherein the size of the pilot guard band is determined based on the maximum Doppler shift information and the maximum delay information in the QCL-TypeE type information.

7. The pilot transmission method according to claim 1, wherein the determining, by a network-side device, at least one pilot resource block in a delay-Doppler domain comprises:
determining, by the network-side device based on pilot resource block configuration information, coordinates and sizes of pilot guard bands of the at least one pilot resource block in the delay-Doppler domain.

8. The pilot transmission method according to claim 7, wherein the determining, by the network-side device, coordinates of the at least one pilot resource block in the delay-Doppler domain comprises:
determining, by the network-side device, coordinates of a target resource block in a delay domain and in a Doppler domain;
wherein the determining, by the network-side device, sizes of pilot guard bands of the at least one pilot resource block in the delay-Doppler domain comprises:
determining, by the network-side device, a width of a pilot guard band of a target resource block in a delay domain and a width of the pilot guard band of the target resource block in a Doppler domain.

9. The pilot transmission method according to claim 1, further comprising:
remapping, by the network-side device based on channel quality-related information of a pilot resource block corresponding to an antenna port, a pilot corresponding to the antenna port to a second pilot resource block.

10. The pilot transmission method according to claim 9, wherein before the remapping, by the network-side device, a pilot corresponding to the antenna port to a second pilot resource block, the method further comprises:
determining, by the network-side device, the second pilot resource block in the at least one pilot resource block; or
re-determining, by the network-side device, in a case that the at least one pilot resource block does not comprise the second pilot resource block, the at least one pilot resource block in the delay-Doppler domain, wherein
a size of a pilot guard band of the second pilot resource block is greater than a size of a pilot guard band of a first pilot resource block.

11. The pilot transmission method according to claim 1, further comprising:
mapping, by the network-side device based on channel quality-related information of a pilot resource block corresponding to the plurality of antenna ports, pilots corresponding to antenna ports having a QCL relationship to a third pilot resource block for transmission.

12. The pilot transmission method according to claim 11, wherein the mapping, by the network-side device based on channel quality-related information of a pilot resource block corresponding to the plurality of antenna ports, pilots corresponding to antenna ports having a QCL relationship to a third pilot resource block for transmission comprises:
determining, by the network-side device for a target antenna port based on a size of a third pilot guard band, the third pilot resource block corresponding to the target antenna port in the at least one pilot resource block, wherein the size of the third pilot guard band is determined based on channel quality-related information of a pilot resource block corresponding to the target antenna port; and
mapping, by the network-side device, the target antenna port to the corresponding third pilot resource block for transmission.

13. The pilot transmission method according to claim 10, wherein the channel quality-related information of the pilot resource block corresponding to the antenna port comprises:
ACK/NACK information and a measurement report that is periodically sent by a terminal, wherein
the measurement report comprises: signal to noise ratio information, signal delay information, Doppler shift information, and bit error rate information that are obtained through measurement by the terminal after receiving the pilot corresponding to the antenna port;
wherein the measurement report is obtained by the terminal based on quality of an uplink pilot measurement channel, or the measurement report is obtained by the terminal based on quality of a downlink pilot measurement channel.

14. The pilot transmission method according to claim 7, further comprising:
sending, by the network-side device, the pilot resource block configuration information to a terminal by using first indication information;
wherein the first indication information is carried by downlink control information DCI or radio resource control RRC information, or, the first indication information is carried in a physical downlink control channel PDCCH or a physical downlink shared channel PDSCH.

15. The pilot transmission method according to claim 14, where the first indication information comprises:
the pilot resource block configuration information; or
index information, wherein the index information is used for indicating pilot resource block configuration information in a predefined pilot resource block configuration table.

16. The pilot transmission method according to claim 15, further comprising:
sending, by the network-side device, the pilot resource block configuration table to the terminal by using second indication information;
wherein the second indication information is carried by a master information block MIB or a system information block SIB, or, the second indication information is carried in a physical broadcast channel PBCH or a PDSCH.

17. The pilot transmission method according to claim 2, wherein the mapping, by the network-side device, pilots corresponding to a plurality of antenna ports to the at least one pilot resource block for transmission comprises:
mapping pilots corresponding to antenna ports that do not have the QCL relationship to different pilot resource blocks for transmission, wherein
sizes of pilot guard bands of the different pilot resource blocks are the same or different.

18. The pilot transmission method according to claim 1, wherein the mapping, by the network-side device, pilots corresponding to a plurality of antenna ports to the at least one pilot resource block for transmission comprises:
making resources occupied by the pilots corresponding to the plurality of antenna ports orthogonal or non-orthogonal.

19. A network-side device, comprising:
a processor; and
a memory storing a program or instructions that is runnable on the processor, wherein the program or instructions, when executed by the processor, causes the network-side device to:
determine at least one pilot resource block in a delay-Doppler domain; and
map pilots corresponding to a plurality of antenna ports to the at least one pilot resource block for transmission,
wherein a pilot corresponding to one antenna port is mapped to one pilot resource block in the at least one pilot resource block.

20. A non-transitory readable storage medium, storing a program or instructions, wherein the program or instructions, when executed by a processor, causes a network-side device to:
determine at least one pilot resource block in a delay-Doppler domain; and
map pilots corresponding to a plurality of antenna ports to the at least one pilot resource block for transmission,
wherein a pilot corresponding to one antenna port is mapped to one pilot resource block in the at least one pilot resource block.
